(19) United States
(12) Patent Application Publication
(10) Pub. No.: US 2015/0339900 A1
(43) Pub. Date: Nov. 26, 2015

(54) Home satellite surveillance defense

(71) Applicant: Michael Lewis Moravitz, Fairfax, VA (US)

(72) Inventor: Michael Lewis Moravitz, Fairfax, VA (US)

(21) Appl. No.: 14/545,346

(22) Filed: Apr. 27, 2015

(51) Int. Cl. G08B 13/00

(52) U.S. Cl. CPC G08B 13/00

(57) ABSTRACT

Patent for home defense against satellite surveillance.

Homes in the future will need defenses against satellite surveillance, as the recent exposes about the National Security Agency show.

Foreign and domestic surveillance programs are a threat to the privacy of civilians. A system can be created to perform several functions: to pull in the signal to a specific location like a WiFi “hotzone” receiver does—away from the home and the areas needed for privacy; to let the occupants of the home know that there are satellite reconnaissance signals at the home; and to ground the signals and to render them inoperable. Pulling the signals into one location would be the essential way to lessen the risk from the surveillance and the main engineering challenge. Grounding the signal in a small “hot zone” in which not much could be surveilled then could be accomplished. This system might also be used to clear signals that interfere with a homeowners.

1. Patents for WiFi receivers;

2. Patents for alarm systems to notify when surveillance is in place;

3. Patents for grounding signals.
